(19) United States
(12) Patent Application Publication
(10) Pub. No.: US 2010/0281082 A1
(43) Pub. Date: Nov. 4, 2010

(54) Subordinate Multiobjects

(75) Inventor: Tatu J. Ylonen, Espoo (FI)

Correspondence Address: TATU YLONEN OY, LTD., KUTOJANTIE 3, ESPOO, 02630, FI

(73) Assignee: TATU YLONEN OY LTD, Espoo (FI)

(21) Appl. No.: 12/432,779

(22) Filed: Apr. 30, 2009

(51) Int. Cl. G06F 17/30

(52) U.S. Cl. 707/816; 707/E17.055

(57) ABSTRACT

Attached and detached subordinate multiobjects provide a means for managing references to within multiobjects in multiobject-based garbage collection (multiobjects are basically linearized trees of objects that are treated as a single unit in various garbage collection operations). Attached subordinate multiobjects provide an efficient means for dealing with transient references from registers, local variables and short-lived data structures, and detached subordinate multiobjects are created when the link connecting an attached subordinate multiobject to its containing multiobject is severed by a write to the data structure.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to garbage collection techniques for automatic memory management in a data processing device.

### BACKGROUND OF THE INVENTION

Various garbage collection methods are described in the book R. Jones & R. Lins: Garbage Collection: Algorithms for Automatic Dynamic Memory Management, Wiley, 1996.

Multiobject garbage collection is described in the co-owned U.S. patent application Ser. No. 12/147,419 by the same inventor, which is incorporated herein by reference. Multiobject garbage collection groups objects in memory into groups called multiobjects. These groups are typically linearized into a predefined order, such as the left-to-right depth-first order. Multiobjects can be used to speed up various garbage collection operations, as well as various other operations, such as serialization of large object graphs.

It was also suggested in that earlier application that the structure of multiobjects could be more liberal than a strict contiguous linearized tree, as writes to within a multiobject may render parts of the multiobject unreachable, and added external references to objects within the multiobject may make it desirable to have nested multiobjects or entries pointing to within multiobjects.

A method for determining the address range of a subtree of a linearized tree has been described in the co-owned U.S. patent application Ser. No. 12/201,514 by the same inventor, which is incorporated herein by reference. That application also describes determining the range of the subtree as it was when the tree was linearized, even if the tree has been modified by writes after it was linearized. It should, however, be understood that other ways of computing the address range of a linearized tree may exist or be invented, and any suitable known or future solution for computing the address range of a part of a multiobject could be used in the various embodiments of the present invention.

Many write barrier implementations are described in the book by Jones & Lins and its references. A further write barrier system that may offer particular advantages in connection with the present invention is disclosed in the co-owned U.S. patent application Ser. No. 12/353,327 by the same inventor, which is incorporated herein by reference. However, any known or future write barrier and write barrier buffer solution could be used in the various embodiments of the present invention.

Tracking changes to the object graph (e.g., writes to pointers within existing objects) and updating the multiobject graph accordingly are important problems in multiobject garbage collection. Similar issues also come up with transient references to objects within multiobjects from registers and local variables.

### BRIEF SUMMARY OF THE INVENTION

The present invention provides an efficient method for dynamically managing the multiobject graph when transient references from registers and local variables are created and when the underlying object graph changes as a result of writes to existing objects. Such writes may make parts of the existing object graph unreachable or may introduce new cycles or shared substructures into the object graph.

The original description of multiobject garbage collection defined a multiobject as a linearized tree of objects with all objects except the root of the multiobject having only one reference. Even though it was suggested that the structure of multiobjects could be relaxed, e.g. by allowing nested multiobjects, the idea was not explored in depth in the earlier disclosure. The present disclosure elaborates this idea into a practical method for dealing with changes to the multiobject graph, and discloses a data processing device that can be used to advantageously implement the method.

The method is based on a few basic ideas, including: allowing multiobjects to be nested within each other (and such nested roots to have more than one reference), allowing gaps (free space) within multiobjects, and the concepts of attached and detached subordinate multiobjects (for multiobjects that have a reference from their parent and those that do not, respectively).

Nested multiobjects make multiobject-based garbage collection practical in real-world systems. Multiobject-based garbage collection may offer significant performance benefits both in very large computer systems with very large memories (tens to hundreds of gigabytes) as well as in power-constrained mobile computing systems (the same efficiency that causes it to run fast on large computers allows it to use fewer instructions and memory accesses, and thus less power, on mobile devices).

### BRIEF DESCRIPTION OF THE SEVERAL VIEWS OF THE DRAWING(S)

FIG. 1 illustrates a top-level multiobject with several subordinate multiobjects.

FIG. 2 illustrates adding a new reference to an object within a multiobject.

FIG. 3 illustrates freeing a (possibly subordinate) multiobject.

FIG. 4 illustrates promoting a multiobject.

FIG. 5 illustrates processing a buffered write.

FIG. 6 illustrates a data processing device according to an embodiment of the present invention.

### DETAILED DESCRIPTION OF THE INVENTION

In the present disclosure, a multiobject is defined as a (semi-)linearized graph of objects where the objects have been stored in a predefined (specific) order. When a multiobject is created, the graph is preferably a tree (that is, only the root of the multiobject may have more than one reference). However, as new references are created to the multiobject, more than one object contained therein may have more than one reference.

Furthermore, it is anticipated that in some future embodiments more liberal multiobject structures may be desirable even when creating a multiobject. As an example of a possible relaxation, objects within the multiobject could be allowed to have more than one reference from within the same multiobject, but only the root (or root of a subordinate multiobject) could have more than one reference from outside the multiobject.

While the present invention may be applicable also to such relaxed multiobjects, in the rest of this disclosure multiobjects are described as being linearized trees with multiple references only at the root of the top-level multiobject and any subordinate multiobjects. It is also assumed that multiobjects may contain gaps, that is, unaccessible space, as a result of some parts of it having been rendered inaccessible by writes.

A subordinate (or nested) multiobject is defined here as a multiobject at least partially embedded within another multiobject (i.e., their address ranges overlap). A top-level multiobject is a multiobject that is not embedded in any other multiobject except its own subordinates. A direct subordinate multiobject means a subordinate multiobject embedded in another multiobject without any other multiobjects in between.

An attached subordinate multiobject (or for short, attached sub, or attached subordinate) is defined as a multiobject that is embedded in another multiobject and is referenced from somewhere in the containing multiobject (the exact location of that reference in the containing multiobject may not be known). Such reference is called an implicit reference.

A detached subordinate multiobject (or for short, detached sub, or detached subordinate) is defined as a multiobject that is embedded in another multiobject but is not referenced from the containing multiobject by an implicit reference. (The detached subordinate may be referenced from the containing multiobject by an explicit reference, that is, by a reference that is not an internal pointer and that is recorded in the remembered sets (e.g. the entry/exit graph).)

A containing multiobject (or parent multiobject) means the smallest multiobject in whose address range the address range of the subordinate multiobject is entirely contained.

In the preferred embodiment, subordinate multiobjects are always properly nested, that is, the address range of a subordinate multiobject is entirely contained within the address range of its containing multiobject and the subordinate multiobject is smaller than its parent multiobject.

It should be understood that the word multiobject is used herein to refer to two subtly different aspects of the same thing: the linearized objects stored in the multiobject space (“the data”), and the multiobject descriptor (called “entry” in the earlier disclosure). Generally a multiobject always has a descriptor and the data. With nested multiobjects, the data (same linearized objects) may be shared between more than one multiobject, whereas each multiobject would generally have its own descriptor.

In the preferred embodiment, the data of each nested multiobject begins at a certain offset within the top-level multiobject, and extends to another (larger) offset within the same top-level multiobject.

The descriptors of subordinate multiobjects need not necessarily be fully expressed as complete “entry” data structures. In some embodiments the containing multiobject may contain a list (or other container data structure) of addresses containing subordinate multiobjects, and full descriptors for such subordinate multiobjects would only be created if actually needed (many transient attached subordinate multiobjects are short-lived, and thus such optimization may yield significant performance benefits). For example, computing the address range of such short-lived multiobject and reparenting contained multiobjects and/or exits could be avoided both when creating and freeing the transient multiobject in such cases. An alternative to the list of addresses could be a bitmap associated with the containing multiobject indicating those offsets that are roots of such incompletely created subordinate multiobjects. The actual creation of the entry object and the related computations and reparentings could be delayed e.g. until the multiobject must be promoted, reparented, or is assigned as the value of an exit (other than exits associated with registers, global variables, or stack slots).

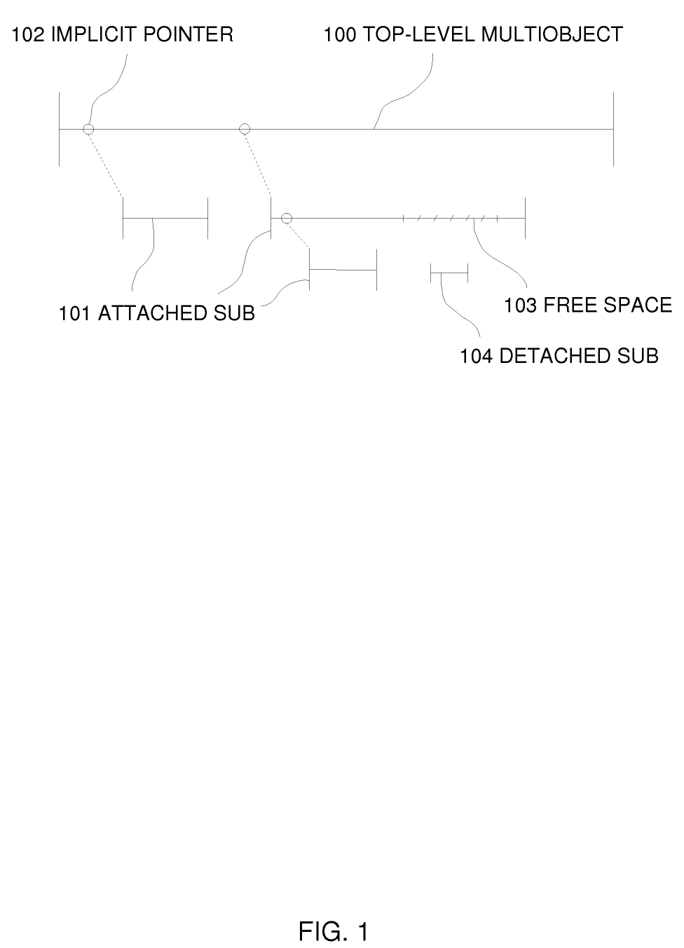

FIG. 1 illustrates a top-level multiobject with several subordinate multiobjects. In the figure, memory addresses run from left to right. (100) illustrates the address range of the top-level multiobject. (101) illustrate attached subordinate multiobjects. (102) illustrates an implicit pointer contained somewhere (exact position generally not known) in the containing multiobject, in this case the top-level multiobject. (103) illustrates space rendered inaccessible by a write to within the multiobject (somewhere outside the shaded area). (104) illustrates a detached subordinate multiobject contained within the inaccessible space (the detached subordinate is accessible if it is still referenced from some live multiobject; however, there is no implicit pointer to it).

Even though the subordinate multiobjects are drawn here as separate lines, their data really shares the same memory addresses with their containing multiobjects. However, they will generally have separate multiobject descriptors (entries). Not shown in the figure is that any of the multiobjects may have references to them (their root objects) from the outside or from within the same multiobject(s); in the preferred embodiment, such references have “exit” objects (popular multiobjects potentially being an exception).

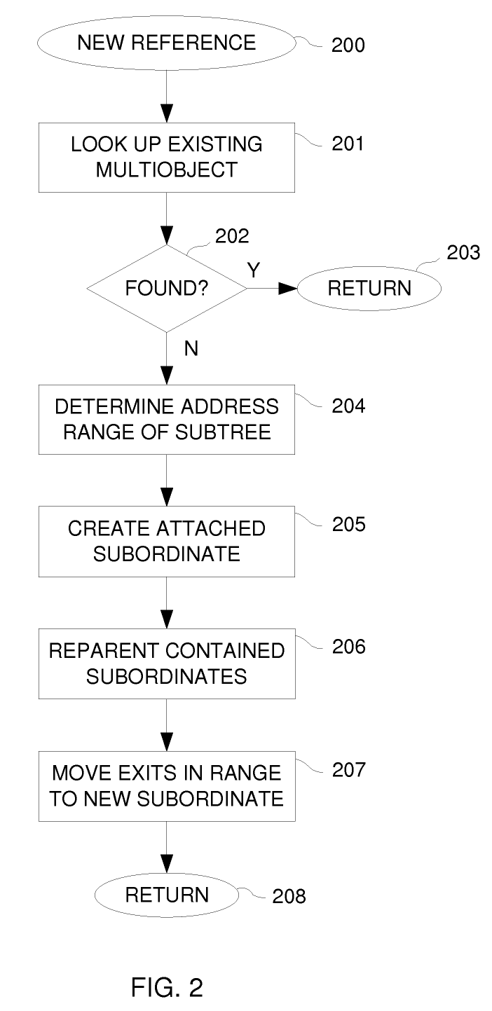

FIG. 2 illustrates adding a new reference to an object in one embodiment of the invention. These steps would typically be performed for the new value when processing writes from a write barrier buffer. They could also be used for any new register or stack slot values at the start of an evacuation pause. The steps are intended for execution on a data processing device comprising a multiobject space and address range determinator. The steps provide one way of implementing a reference creator element for a data processing device; the steps themselves could be implemented in software or in hardware (e.g. as digital logic in an ASIC).

The process for adding a new reference starts at (200). It gets as input a pointer to the referenced object (preferably its address or tagged pointer). At (201), a lookup is made to see if a multiobject rooted at this address already exists. This lookup may utilize e.g. a hash table, a search tree, or any other suitable index data structure known in the art. At (202), control branches to (203) to return the already existing multiobject if one was found. Otherwise, control passes to (204) to determine the address range of the subtree rooted at the referenced object. In some embodiments it is desirable to find the address range of the subtree as it was when the top-level multiobject was created, before earlier modifications by writes to within the same multiobject. At (205) the multiobject (its descriptor) is created (it may also be added to various index data structures), and at (206) any previously existing subordinate multiobjects in the address range are reparented to be contained within the new multiobject, and at (207) any exits contained in the address range are moved to be stored in the new subordinate multiobject. Finally, at (208), the attached subordinate creation is complete.

It should be understood that many alternatives are possible for structuring the multiobject hierarchy. They may be stored in a single index data structure by their starting address, or each multiobject may contain an index data structure of its direct subordinate multiobjects. A multiobject (descriptor) may or may not contain a pointer to its containing multiobject and/or its top-level multiobject. Exits may be stored in a data structure associated with each multiobject, or in a data structure associated with a top-level multiobject, in a data structure associated with the independently collectable memory region containing the multiobject, or globally. The choice may be affected by concurrency control considerations.

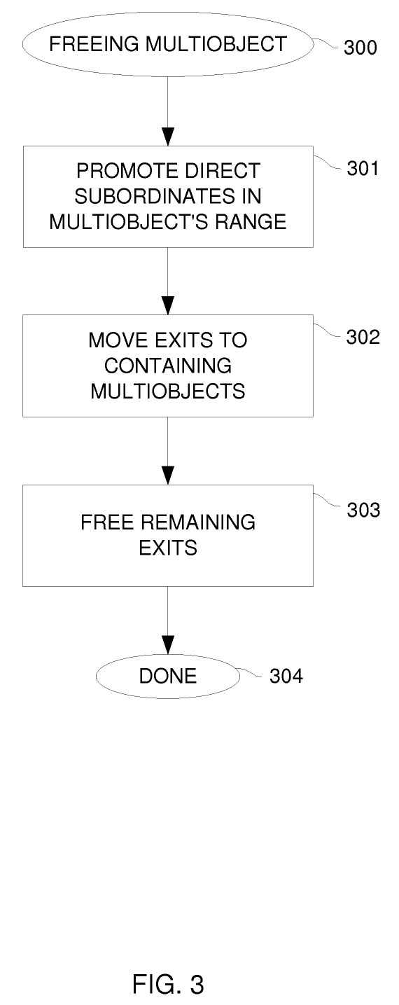

FIG. 3 illustrates freeing a multiobject in one embodiment of the invention. A multiobject may be freed after it is no longer referenced from any live multiobject. Possible alternatives for determining when it can be freed include but are not limited to freeing it when a multiobject-level transitive closure computation determines that it is no longer reachable; freeing it immediately when its list of referring exits becomes empty; freeing it at the end of an evacuation pause if it is only referenced from transient exits in addition to its implied reference from its containing multiobject; freeing it when its reference count becomes zero.

The freeing process begins at (300). At (301), direct subordinates in the address range of the multiobject are promoted. At (302), exits are moved to the containing multiobject. At (303), any exits remaining in the address range (i.e., those that did not belong to any direct subordinates) are freed. At (304) freeing is complete. (Not shown are the steps normally performed when freeing any multiobject, including in many embodiments e.g. removing the entry objects from index data structures, freeing the entry data structures, updating any bookkeeping about free space, or updating the gc_index of the region.)

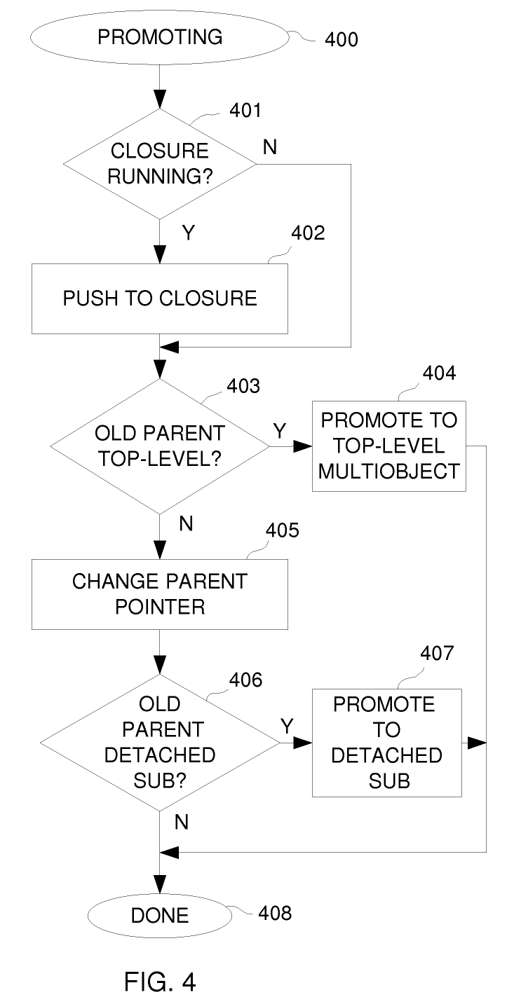

FIG. 4 illustrates promoting a subordinate multiobject in one possible embodiment of the present invention. Promotion is the process of making an attached subordinate multiobject a detached subordinate or a top-level multiobject, or making a detached subordinate a top-level multiobject. Promotion is typically performed when a write renders an address range within a multiobject unreachable for all direct subordinate multiobjects within that range. Promotion also involves reparenting.

The promoting process starts at (400). At (401) and (402), if the transitive closure is running, the multiobject being promoted may be caused to be visited by the transitive closure computation (in order to implement snapshot-at-the-beginning semantics for the transitive closure computation; similar code would go into adding a new reference in some embodiments). Embodiments that do not utilize snapshot-at-the-beginning multiobject-level transitive closure computation may not have these steps.

At (403) it is checked if the old parent is a top-level multiobject. If so, at (404) the multiobject being promoted is made a top-level multiobject. (In some embodiments the old top-level multiobject might be left as a placeholder for the memory area, basically denoting free space except for remaining subordinate multiobjects, in which case the multiobject being promoted might be turned into a detached subordinate rather than a top-level multiobject, if it is not already one. A similar choice exists also in other promotion situations.)

At (405) the multiobject is reparented, i.e., its parent pointer (if any) is changed, and if each multiobject has its own index of immediate subordinate multiobjects, then the multiobject being promoted would be moved to the index of its new parent. This may also involve other index/data structure maintenance, depending on the embodiment.

At (406) it is checked if the old parent multiobject was a detached subordinate multiobject. If so, then at (407) the multiobject being promoted is turned into a detached subordinate multiobject (if it is not already one).

At (408) the promotion is complete, and the old parent multiobject can be freed (if desired).

In some embodiments there is a variation of the promotion operation that could better be called reparenting. The full promotion is performed e.g. when the multiobject to be promoted is rendered inaccessible (no longer reachable by an implicit pointer), whereas the reparenting variant can be used when the parent multiobject is an attached subordinate that is freed, in which case its subordinate multiobjects are just moved to be direct subordinates of its parent. The reparenting operation roughly corresponds to steps (400) to (402) and (405).

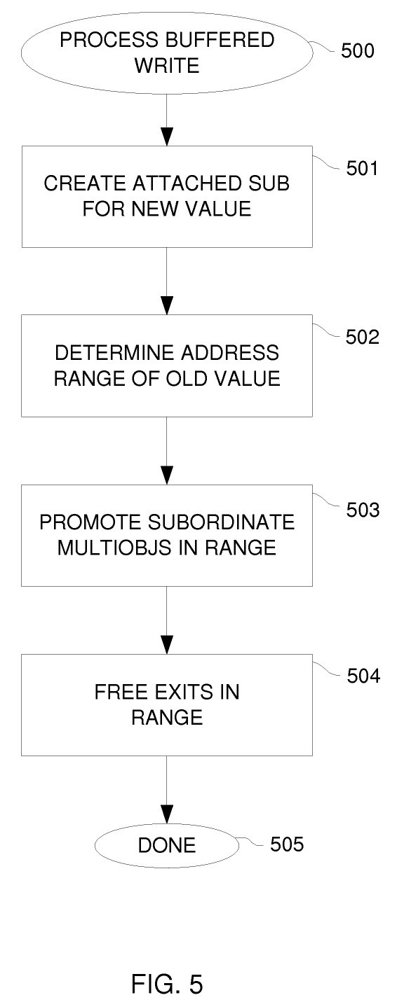

FIG. 5 illustrates processing writes from a write barrier buffer. It would also be possible to process each write as it occurs; however, in most embodiments it is more advantageous to buffer writes using any known write barrier mechanism and combine repeated writes to the same location between two consecutive evacuation pauses (the term evacuation pause here also including the much shorter synchronization pauses in real-time garbage collectors). The method illustrated in FIG. 5 assumes that the old value of the written cell is saved by the write barrier (the old value refers to the value it had last time write barrier buffers for that address were processed—typically the value it had at the end of the previous evacuation pause).

Basically the write barrier provides a means for trapping object graph changing writes in the system. Write barriers usually filter the writes, and only store those writes (and corresponding old values) in the write barrier buffer that need special handling (typically when either the old or the new value, or both, contain a pointer, depending on the particular embodiment). Many write barriers combine writes to the same memory address to reduce space overhead and processing time.

The processing for a single written address and old value begins at (500). (For processing an entire write barrier buffer containing many addresses, these steps are repeated for each address.) At (501) an attached subordinate is created for each new value of a written cell (the new value, meaning the most recently written value, can be read from the written memory address, though it could also be saved by the write barrier. This step is only necessary if the new value refers to an object in memory (some embodiments may also support immediate values, such as small integers, that do not contain pointers, and this step can be skipped for such objects).

At (502) the address range of the subtree rooted at the old value is determined. (Since the written address can be an internal pointer, there may not be a multiobject rooted at that address—if there is, it may be possible to simply read the range from the multiobject's descriptor in some embodiments.) In the preferred embodiment the range is always determined as it was when the top-level multiobject was created, before any writes that may have modified it between its creation and execution of this step.

If the old value was not a pointer to an object, then steps (502) to (504) may be skipped.

At (503) any subordinate multiobjects in the old value's range are promoted by utilizing the method illustrated in FIG. 4 or some other method with similar effect.

At (504) any exits (the descriptor objects for such exits) remaining in the address range are freed.

The operation is complete at (505).

In some embodiments some of the steps may be skipped for certain kinds of values. For example, it may be unnecessary to maintain exits or compute ranges for pointers to large objects or popular objects.

An aspect of the present invention is a method of managing memory in a data processing device comprising a reference creator, the method comprising:
identifying at least one object with a new reference, said object being within an existing multiobject but not the root of that multiobject; and
creating an attached subordinate multiobject whose root object is said object and whose containing multiobject is said existing multiobject.

The write barrier basically provides a means for identifying which cells have been written. The objects pointed to by the new values of those cells are identified as having a new reference. Some of those objects with a new reference will be within an existing multiobject but not the root of that multiobject. Steps (201) to (203) illustrated identifying which objects with a new reference are not roots of existing multiobjects. Since the multiobject space only contains multiobjects (and free space) in the preferred embodiment, any pointers to within the multiobject space must be pointers to within existing multiobjects (within a multiobject here means within the address range of the multiobject, but not within the address range of any of its subordinate multiobjects).

Creating the attached subordinate multiobject can be performed for example as illustrated in FIG. 2, particularly steps (204) to (207).

In many embodiments, each attached subordinate multiobject is represented by a data structure comprising at least information from which the address of the attached subordinate multiobject can be determined. As discussed earlier, this can be e.g. a full entry data structure, an address stored in a list or other container data structure, or a bit representing a particular offset within a multiobject.

In many embodiments of the present invention, when an attached subordinate multiobject is created, its address range is determined and one or more subordinate multiobjects in that address range are reparented to be direct subordinates of the new subordinate multiobject.

The determination of address ranges may also be delayed, such that when a new subordinate multiobject is created, its address range is marked as not yet computed (e.g. by storing a special value, such as zero, in the address range fields), and when the address range fields are first used (their value needed), determining the address range and performing any required reparenting or exit moving operations. This way, the determination of the address range and reparenting contained multiobjects can be avoided if the new multiobject is freed before its range and/or the reparenting operations are needed.

Many embodiments of the invention also comprise moving exits in the address range of the new multiobject to new multiobject; however, this depends on where the exits are stored, as discussed earlier.

When the containing multiobject of a subordinate multiobject is freed, any subordinate multiobjects in its range need to be promoted in many embodiments. If the containing multiobject is a top-level multiobject, its direct subordinate multiobjects may be promoted to top-level multiobjects. If it is a detached subordinate multiobject and its direct subordinate multiobject is an attached subordinate multiobject, then the attached subordinate multiobject may be promoted to a detached subordinate multiobject.

Promotion also takes place in many embodiments when a write occurs to a pointer cell that contains an internal pointer. Then, the address range of the old value is determined, and at least one attached subordinate multiobject (if there are any in the range) is promoted to a detached multiobject.

For the purposes of many garbage collection operations multiobjects with subordinate multiobjects are treated as a single unit. For example, when moving a top-level multiobject, any attached subordinate multiobjects contained therein must be moved along with the containing multiobject in order to retain structure sharing (this is important in programming environments with destructive writes; functional programming environments may relax this requirement). Detached subordinates may or may not be moved along with their containing top-level multiobject. The reconstruction method described in the prior disclosure can be used to reconstruct a multiobject from which some space has been rendered inaccessible to be contiguous, and to move detached multiobjects out from within their containing multiobjects (essentially making them top-level multiobjects). The starting addresses of the subordinate multiobjects must be updated as they are moved (if the entire top-level multiobject is simply copied as-is, then the subordinate multiobject addresses change by the same amount; if it is reconstructed, then the new address can e.g. be saved when the root object is copied—this may be speeded up e.g. by preparing a bitmap indicating which offsets contain subordinate multiobject root objects, and only looking up the subordinate multiobject to save its new address when the bit corresponding to the object currently being copied is set).

When a subordinate multiobject is moved (whether with its containing multiobject, or made a new top-level multiobject), any pointers referencing that multiobject must be updated. Such updating is very similar to the updating already described in the previous disclosure for ordinary (top-level) multiobjects.

In many embodiments the method further comprises buffering writes during mutator execution using a write barrier and a write barrier buffer. In the preferred embodiment, both the written address and the old value of that cell are saved, and each address is saved only once (when it is first written since the last time the write barrier buffers were processed). The processing of each written address is illustrated in FIG. 5.

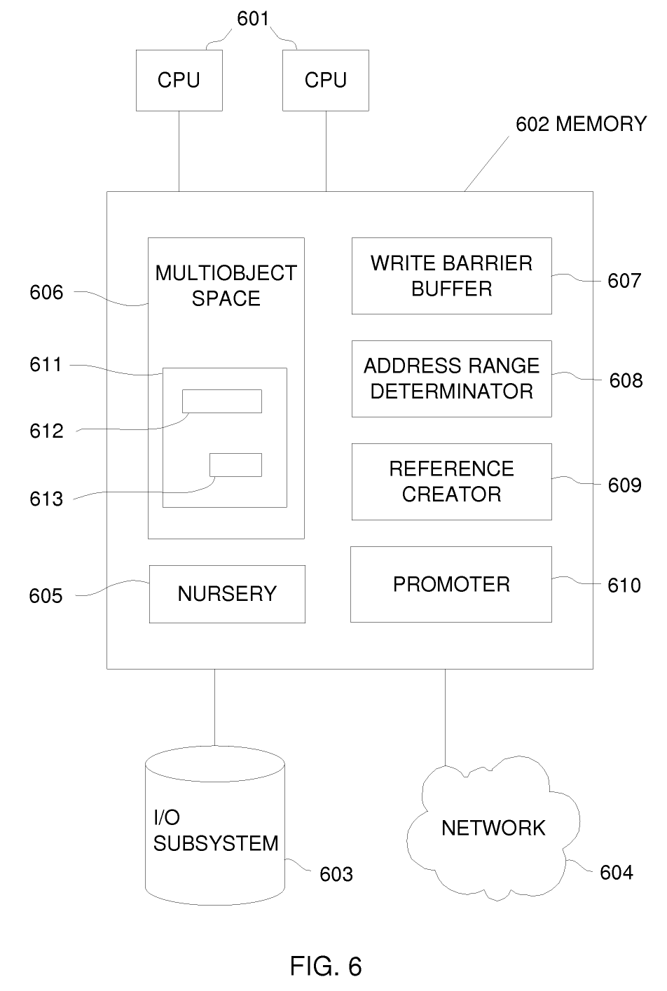

A data processing device aspect of the present invention is illustrated in FIG. 6. Many different data processing device embodiments are possible, and different elements of the device may be implemented in software or hardware, as is most appropriate in each embodiment.

Known elements of a data processing device include one or more processors (601), one or more memory devices (602), an I/O subsystem including non-volatile storage devices (603), and a network interface (604) connecting the data processing device to a communications network (such as the Internet, a high-speed interconnect network, or a wireless network).

According to the present invention, the data processing device also comprises at least one nursery memory area (605) comprising objects that have not yet been grouped into multiobjects. Typically new objects are created in the nursery (though in some embodiments multiobjects might be loaded directly into the multiobject space from persistent storage or over a network). The nursery may comprise more than one generation or independently collectable memory region.

The data processing device also comprises at least one multiobject space (606) used for storing multiobjects. Typically the multiobject space comprises a large number of multiobjects. Top-level multiobjects are stored in the multiobject space in non-overlapping address ranges. At least one of the top-level multiobjects has been constructed from objects in the nursery.

In many embodiments the data processing device also comprises one or more of the following: a write barrier buffer (607), which may be any known write barrier buffer component that provides access to the old value of the written cells (roughly the operations illustrated in FIG. 5 are performed on the values obtained from the write barrier buffer); an address range determinator (608) for determining the address range of a subtree of a linearized tree (in some embodiments, of the original version thereof) (any known or future subtree address range determination method may be employed by the component); a reference creator (609) performing roughly the steps illustrated in FIG. 2 or comparable functionality; and a promoter (610) performing roughly the steps illustrated in FIG. 4.

The data processing device also comprises at least one subordinate multiobject stored within the address range of one of the top-level multiobjects (611). The subordinate multiobject may be either an attached subordinate multiobject (612) or a detached subordinate multiobject (613). (Some embodiments, particularly those relating to functional programming languages, may not have detached subordinates.)

The reference creator means a component of the data processing device that creates new subordinate multiobjects when new references are added to objects contained within an existing multiobject. While in the preferred embodiment it implements roughly the steps illustrated in FIG. 2, this is not intended to limit the actions that it may perform. For example, if the multiobject structure is further relaxed, the way of determining the address range of a subordinate multiobject may be very different, or the whole creator may be structured such that it avoids determining the range.

A further aspect of the present invention is a computer program product, stored on a computer readable medium, operable to cause a data processing device to:
comprise a reference creator
identify at least one object with a new reference, said object being within an existing multiobject but not the root of that multiobject; and
create at least one attached subordinate multiobject whose root object is said object and whose containing multiobject is the multiobject that contains said object.

The exact semantics and organization of subordinate multiobjects could be varied by one skilled in the art, with corresponding changes in how the space used by subordinate multiobjects is taken into account. Even though multiobjects were described as forming a hierarchy, they could also be arranged on a linear axis (e.g. by memory addresses). A known range index data structure could be used for organizing them. As an alternative to having nested multiobjects, one could have discontiguous multiobjects, were a multiobject would be split if another multiobject was created within it. Such multiobjects could be merged when a multiobject between such parts is freed. Such approaches would still be essentially equivalent with the present invention.

Many variations of the present invention will be within reach of an ordinary person skilled in the art. Many of the steps in the methods could be rearranged, or operations grouped differently into components of a data processing device, without deviating from the spirit of the invention. When an element or step is mentioned in the claims, the intention is to mean that one or more such elements may be present. When multiple steps are listed, the intention is to say that the steps may take place in any order or possibly simultaneously, subject only to data flow constraints (i.e., the values used by a step must be available before they are used by the step). When a known computing method or algorithm is mentioned in the description or claims, the intention is that any known or future variant or known algorithm for solving the same problem can be used, any specific algorithm variant mentioned serving only as an example.

It is to be understood that the aspects and embodiments of the invention described herein may be used in any combination with each other. Several of the aspects and embodiments may be combined together to form a further embodiment of the invention. A method, a data processing device, or a computer program product which is an aspect of the invention may comprise any number of the embodiments or elements of the invention described herein.

What is claimed is:

1. A method of managing memory in a data processing device comprising a reference creator, the method comprising:
identifying at least one object with a new reference, said object being within an existing multiobject but not the root of that multiobject; and
creating at least one attached subordinate multiobject whose root object is said object and whose containing multiobject is said existing multiobject.

2. The method of claim 1, further comprising:
representing said attached subordinate using a data structure, the data structure comprising at least information from which the address of said object can be determined.

3. The method of claim 1, further comprising:
when creating an attached subordinate multiobject:
determining the address range of the subtree rooted at said object; and
reparenting at least one subordinate multiobject within the address range.

4. The method of claim 1, further comprising:
when an attached subordinate multiobject is created, marking that its address range has not yet been computed;
when the address range of the subordinate multiobject is first needed:
determining the address range of the subtree rooted at said object; and
reparenting at least one subordinate multiobject within the address range;
thereby avoiding determining of the address range of the multiobject and reparenting the at least one subordinate multiobject if the newly created multiobject is freed before they are needed.

5. The method of claim 1, further comprising:
determining the address range of the subtree rooted at said object; and
moving exits in the address range to the created attached subordinate multiobject.

6. The method of claim 1, further comprising:
at the end of a transitive closure computation, freeing at least one attached subordinate multiobject that is no longer reachable.

7. The method of claim 1, further comprising:
freeing at least one attached subordinate multiobject when its list of exits referencing it becomes empty.

8. The method of claim 1, further comprising:
at the end of an evacuation pause, freeing at least one attached subordinate multiobject that is only referenced from transient exits in addition to the implied reference from its containing multiobject.

9. The method of claim 1, further comprising:
freeing a subordinate multiobject when its reference count becomes zero.

10. The method of claim 1, further comprising:
when the containing multiobject of a first subordinate multiobject is freed, if the containing multiobject is a top-level multiobject, promoting the first subordinate multiobject to a top-level multiobject.

11. The method of claim 1, further comprising:
when the containing multiobject of a first subordinate multiobject is freed, if the containing multiobject is a detached subordinate multiobject and the first subordinate multiobject is an attached subordinate multiobject, promoting the first subordinate multiobject to be a detached subordinate multiobject.

12. The method of claim 1, further comprising:
when a write occurs to a pointer cell that contains an internal pointer:
determining the address range of the object pointed to by the old value of that cell; and
promoting at least one attached subordinate multiobject within such address range to be a detached subordinate multiobject.

13. The method of claim 1, further comprising:
if a transitive closure computation is running when a multiobject is promoted, causing the multiobject computation to visit the promoted multiobject.

14. The method of claim 1, further comprising:
computing a transitive closure of the multiobject graph; and
when a multiobject is deemed reachable during the transitive closure computation, causing any attached subordinate multiobject directly contained in it to be deemed as reachable.

15. The method of claim 1, further comprising:
when moving a containing multiobject, moving at least one subordinate multiobject along with the containing multiobject.

16. The method of claim 15, further comprising:
updating pointers referring to said at least one subordinate multiobject to point to the new location of said at least one subordinate multiobject.

17. The method of claim 1, further comprising:
buffering writes during mutator execution using a write barrier buffer such that for each written address the old value of the written cell is saved;
when processing write barrier buffers, for at least one written cell:
creating an attached subordinate multiobject for the new value of the written cell;
determining the address range of the subtree rooted at the object pointed to by the old value of the written cell; and
promoting at least one attached subordinate multiobject within the address range.

18. The method of claim 1, further characterized by each subordinate multiobject being properly nested within its containing multiobject.

19. A data processing device comprising:
at least one nursery memory area comprising objects that have not yet been grouped into multiobjects;
at least one multiobject space comprising one or more top-level multiobjects, at least one of which has been constructed from objects in the nursery memory area;
a reference creator; and
at least one attached subordinate multiobject whose data is stored within the address range of one of the top-level multiobjects, said multiobject having been created by the reference creator.

20. The data processing device of claim 19, further comprising at least one detached subordinate multiobject contained within the address range of one of the top-level multiobjects.

21. The data processing device of claim 19, further comprising a data barrier buffer for recording writes that occur to within multiobjects, the buffer capable of storing the address and the old value of at least one written cell.

22. The data processing device of claim 19, further comprising at least one subtree address range determinator.

23. The data processing device of claim 19, further comprising at least one reference creator.

24. The data processing device of claim 19, further comprising at least one promoter.

25. A computer program product operable to cause a data processing device to:
comprise a reference creator;
identify at least one object with a new reference, said object being within an existing multiobject but not the root of that multiobject; and
create at least one attached subordinate multiobject whose root object is said object and whose containing multiobject is the multiobject that contains said object.
